(19) United States
(12) Patent Application Publication
(10) Pub. No.: US 2011/0188699 A1
(43) Pub. Date: Aug. 4, 2011

(54) WOVEN OR KNITTED FABRIC, DIAPHRAGM FOR SPEAKER, AND SPEAKER

(75) Inventors: Hiroshi SHIBAOKA, Hikone-shi (JP); Sunao TAKAHIRA, Takarazuka-shi (JP); Tatsuhiko NINOMIYA, Kashiba-shi (JP); Emiko SHIBATA, Osaka-shi (JP)

(73) Assignee: KB SEIREN, LTD., Sabae-shi (JP)

(21) Appl. No.: 13/038,482

(22) Filed: Mar. 2, 2011

Related U.S. Application Data
(62) Division of application No. 10/591,989, filed on Apr. 5, 2007.

(30) Foreign Application Priority Data
Mar. 8, 2004 (JP) 2004-064608
Jul. 8, 2004 (JP) 2004-202161

(51) Int. Cl. H04R 1/00

(52) U.S. Cl. 381/428

(57) ABSTRACT

A speaker having a diaphragm made of a woven/knitted fabric containing a conductive fiber and a non-conductive fiber, where the fabric has a woven structure or a knitted structure of the non-conductive fiber, and a continuous wiring forming a coil of the conductive fiber.

This application is a division of Ser. No. 10/591,989, filed Apr. 5, 2007, which is a filing under 35 USC 371 of PCT/JP2005/003875 filed Mar. 7, 2005, which claims the priority of JP 2004-064608 filed Mar. 8, 2004 and JP 2004-202161 filed Jul. 8, 2004, the prior applications being incorporated herein by reference.

### FIELD OF THE ART

The invention relates to a woven/knitted fabric, a diaphragm for a speaker, and a speaker.

### BACKGROUND ART

A conventional flat type speaker is provided with a rod-type magnet and a diaphragm in which a coil is formed. This flat type speaker vibrates the diaphragm by applying alternating electric current to the respective portions of the coil and accordingly converts the electric signals into acoustic signals. As a diaphragm for a speaker installed to such a speaker, those which comprise a coil formed by printing on a diaphragm made of pulp, a thermoplastic resin film, a FRP (a fiber-reinforced plastic) or the like have been known (reference to Japanese Kokai Publication 2000-152378 and Japanese Kokai Publication 2003-299184).

Japanese Kokai Publication 2000-152378 discloses a flat type acoustic-conversion apparatus in which a magnet, a coil, and a diaphragm have specified constitutions. With respect to this kind flat type acoustic-conversion apparatus, the coil on the diaphragm is formed by at first forming a copper thin film on a polymer film of a polyimide, polyethylene, or the like by a lamination or vapor deposition method and successively etching the formed copper thin film in a manner of forming a spiral plane form.

Japanese Kokai Publication 2003-299184 discloses a coil-united diaphragm comprising a coil and wiring whose electric current path is divided into a plurality of portions on the surface of the diaphragm. With respect to this coil-united type diaphragm, the coil on the diaphragm is formed by at first forming photoresist in a coil pattern on an acrylic type film or an imide type film by a photolithographic method and successively carrying out electroless copper plating treatment, photoresist separation, and electrolytic copper sulfate plating treatment.

As described, conventionally, since a coil in a diaphragm for a speaker is to be formed by printing by a method of etching, metal plating or the like, complicated steps are required to produce the coil in the diaphragm and the production cost is elevated. Therefore, it has been desired to produce a diaphragm for a speaker by a simple method and to lower the production cost.

On the other hand, a fabric using a conductive fiber has been known well and been used a plane heat generator, a laminate for multilayer wiring, or the like. For example, Japanese Kokai Publication Sho 50-83561 discloses a production method of a fabric for electric communication by winding a thermoplastic synthetic fiber of a low melting point polymer and a non-conductive fiber in a conductive strand or weaving a fabric using a strand as a weft, successively heating the fabric for melting only the thermoplastic synthetic fiber of a low melting point polymer. The fabric for electric communication produced by the method disclosed here uses the conductive strand for all of the weft and is for heating or keeping heat by electric power application or for preventing electric charge of static electricity of carpets or clothes by weaving a strand containing a metal fiber.

Japanese Kokai Publication Hei 8-92841 discloses a glass fiber fabric of which portions of the weft and the warp are replaced with a metal wire, in which the metal wire is woven in a manner that it contacts crossing points, and which can be suitably used for a laminate for a multilayer wiring board. The glass fiber fabric disclosed here consists of the metal wire woven therein and having contact at crossing points and does not form a coil-like shape in the fabric.

Japanese Kokai Publication 2000-199140 discloses a fabric in which a metal wire having a high heat conductivity is woven together with an animal or plant fiber and/or a chemical fiber. The fabric disclosed here is capable of efficiently heating or cooling the metal wire to a high temperature or a low temperature owing to the heat conductivity and thereby warming or cooling partially or entirely a human body by transmitting the heat or the cold to a part or the entire part of clothing and thus the metal wire does not form a coil-like shape in the fabric.

Japanese Kokai Publication 2000-219076 discloses an electrode material for object or human body detection system which is obtained by weaving or knitting a conductive fiber partially in a substrate and is to be used for a system for detecting existence of an object by disposing a plurality of electrode materials. The woven/knitted fabric disclosed here is the electrode material to be used for object or human body detection system and thus the conductive fiber does not form a coil-like shape in the woven/knitted fabric.

As described above, the woven/knitted fabrics disclosed in Japanese Kokai Publication Sho 50-83561, Japanese Kokai Publication Hei 8-92841, Japanese Kokai Publication 2000-199140, Japanese Kokai Publication 2000-219076 are used for heating or keeping heat, prevention of electric charge of static electricity, a laminate for a multilayer wiring board, an electrode material etc. and cannot be used as a diaphragm for a speaker.

### DISCLOSURE OF THE INVENTION

### Problems to be Solved by the Invention

In view of the above state of the art, the invention aims to provide a woven/knitted fabric containing a conductive fiber preferably usable especially for a diagram for a speaker, and a diaphragm for a speaker and a speaker using the woven/knitted fabric.

### Means for Solving the Problems

The invention provides a woven/knitted fabric comprising a conductive fiber and a non-conductive fiber, wherein the woven/knitted fabric has a woven structure or a knitted structure of said non-conductive fiber and a continuous wiring forming a coil of the conductive fiber.

The coil is preferably formed in the woven structure or the knitted structure by weaving or knitting the conductive fiber by a weaving machine or a knitting machine.

Preferably, at least a portion of the non-conductive fiber is a fusible yarn.

The conductive fiber is preferably a copper wire.

The invention also provides a diaphragm for a speaker comprising the woven/knitted fabric mentioned above.

The invention also provides a speaker comprising the diaphragm for a speaker mentioned above.

The speaker preferably comprises a buffer material between the diaphragm for a speaker and a magnet.

The speaker is preferably as an interior material for a room or an automobile.

The invention also provides a noise control system using the speaker mentioned above.

The invention also provides a sound navigation system using the speaker mentioned above.

The invention also provides a display equipped with sound guidance using the speaker mentioned above.

Hereinafter, the invention will be described more in detail.

A woven/knitted fabric of the invention has a woven structure or a knitted structure of a non-conductive fiber and a continuous wiring forming a coil of a conductive fiber and is preferably useful especially for diaphragm for a speaker.

The woven/knitted fabric of the invention comprises the coil made of a conductive fiber and the woven structure or the knitted structure of a non-conductive fiber. A conventional diaphragm for a speaker is formed by printing on a substrate of a diaphragm by an etching or metal plating method. Therefore, there are problems that it requires complicated steps of forming the coil in the diaphragm and that the production cost is high. On the other hand, the woven/knitted fabric of the invention can be produced easily using a conductive fiber and a non-conductive fiber by weaving the fiber with a weaving machine or knitting the fiber with a knitting machine. Accordingly, as compared with a conventional production method of the coil by printing, the method of the invention is simple and capable of producing a diaphragm for a speaker and consequently lowering the production cost.

Since the woven/knitted fabric of the invention comprises the coil made of a conductive fiber and the woven structure or the knitted structure of a non-conductive fiber, it is excellent in the durability against sagging and bending. Accordingly, it can be transported while being rolled at the time of transportation and therefore, the transportation cost is also lowered as compared with a conventional one.

The woven/knitted fabric of the invention is thin and accordingly usable as a diaphragm for a speaker which is required to be thin. For example, it can be used preferably for a diaphragm for a flat speaker and usable in a flat display of a mobile phone and a television.

Since the above-mentioned diaphragm for a speaker is a cloth, it can be used for adding a function as a speaker to interior materials for a room such as a table cloth, a pillow cover, a cushion, a massage sheet, a roll curtain, and a hanging scroll, and to interior materials for an automobile which are generally use for a cloth.

Also, the diaphragm for a speaker is durable to sagging and bending, in the case of using it for a screen for displaying images by a projector or the like, it can work as a speaker when being used and it may be stored while being rolled when it is not used. Also, since it can be rolled in form of a roll, it is easy to be conveyed and carried together at the time of a trip. Further, it can be used for a display equipped with sound guidance (e.g. a guide board for traffic guidance, sightseeing guidance, street marks and the like; and a display for explanations in exhibitions and meetings). Such a guide board can be attached to a column-type pole and can generate sound all around.

Further, the diaphragm for a speaker is easy to be installed and disassembled, it can be installed in the inside of a station and a concourse, a street, an utility pole, an external wall, and the like as a speaker for sound guidance for guiding the people visited at the time of event performance or the like. In the case of using it for such purposes, it scarcely requires an installation space for speaker installation and thus it can be installed even in an extremely narrow space or attached to a wall or a pole without any problem. Further, it can be installed at any needed space at the time of event performance and easily taken off at the time of closing the event and thus it is very convenient and excellent in the usability. Therefore, the above-mentioned speaker can be used preferable for a sound navigation system.

The above-mentioned speaker can be used for a noise control system. Unlike a sound-insulating material which insulates sound from the outside but cannot suppress the noise or vibration generated inside, the above-mentioned noise control system is for suppressing noise by generating sound with reverse phase to that of the noise. The speaker of the invention can be installed easily in a sheet for vehicles, a sound-insulating wall of an expressway, or a wall of an industrial plant, so that it can be used preferably as a speaker for the above-mentioned noise control system. Especially, since the speaker is flat, it is easy to install the speaker in a sound-insulating wall or a wall of an industrial plant and also since it is a cloth, it can be used as an interior material for an automobile such as a sheet for a vehicle and in terms of that, it is preferable.

The woven/knitted fabric of the invention is made compact and thin in the thickness as compared with a conventional diaphragm for a speaker in which a diaphragm and a coil are separate parts. Also, it is improved in the durability as compared with a conventional diaphragm for a speaker obtained by etching on a film and the coil of it is thus hard to be cut.

In the woven/knitted fabric of the invention, the woven structure of the non-conductive fiber is not particularly limited and may include those formed by weaving methods such as plain weaving, twill weaving and sateen weaving, or arranged method thereof. In terms of high weaving density, twill weaving is preferable. Further, it may be a single woven fabric or a multiple-woven fabric such as a double-woven fabric. The knitted structure of the non-conductive fiber is not particularly limited and those formed by knitting methods such as weft stitch, warp stitch and lace stitch, or arranged method thereof. The woven fabric is more preferable than the knitted fabric, because it is easy to form a structure in which a conductive fiber is woven and it can be made easily to a thin and smooth structure which achieves a function as a diaphragm suitably.

In the woven/knitted fabric of the invention, the above-mentioned non-conductive fiber is an insulating fiber other than the above-mentioned conductive fiber and those which are used as a fiber material for a woven/knitted fabric may be used without any limit and examples are synthetic fibers, e.g. polyester fibers such as polyalkylene terephthalate; polyamide fibers such as nylon 6, 66, and 46; aromatic polyamide fibers (aramide fibers) such as copolymers of p-phenylene terephthalamide and aromatic esters; poly(p-phenylene benzobisoxazole); fully aromatic polyester fibers (polyarylate fibers); vinylone fibers; rayon fibers; polyolefin fibers of very high molecular weight polyethylene or the like; polyoxymethylene fibers; sulfone type fibers such as p-phenylene sulfone and polysulfone; polyether ether ketone fibers; polyether imide fibers; carbon fibers; and polyimide fibers; chemical fibers such as rayon; and natural fibers such as cotton, silk, and wool. Also, inorganic fibers such as glass fibers and ceramic fibers may be used alone or in combination. Among them, in terms of the lightweight, heat resistance, durability, compactness, and cost, polyester multifilaments are preferable. They may be used alone or two or more of kinds of them may be used in combination. The above-mentioned non-conductive fiber maybe a single yarn or two or more parallel yarns. In the case of using fibers for a diaphragm for a speaker, filaments are preferable in terms of the sound quality.

The above-mentioned polyester multifilaments are preferably to have total fineness in a range from a lower limit of 33 dtex to an upper limit of 1000 dtex. If it is less than 33 dtex, the balance with a copper wire becomes inferior and the sound tends to echo. If it exceeds 1000 dtex, the balance with a copper wire becomes inferior and it becomes thick or heavy and therefore, vibration becomes difficult to make sound generation difficult. The above-mentioned total fineness is more preferably in a range from a lower limit of 100 dtex to an upper limit of 600 dtex and still more preferably in a range from a lower limit of 100 dtex to an upper limit of 400 dtex.

The single yarn fineness is preferably in a range from a lower limit of 1 dtex to an upper limit of 33 dtex and more preferably in a range from a lower limit of 1 dtex to an upper limit of 10 dtex. Since if the woven/knitted fabric has a smoother surface, it works more efficient as a diaphragm, a double folded yarn is more preferable than a single yarn and a double folded yarn composed of an upper twisted yarn and a lower twisted yarn in combination is also preferable.

The above-mentioned non-conductive fiber is preferable to be at least a partially fused yarn. Accordingly, the above-mentioned conductive fiber can be fixed firmly in the woven/knitted fabric. For example, in the case where the above woven/knitted fabric is used for a diaphragm for a speaker, shift of the woven structure or the knitted structure is suppressed and therefore, an excellent function can be provided. In the case of the woven structure, the fused yarn may be used for a warp, a weft, both of the warp and the weft. The fused yarn is further preferable to be used for both of the warp and the weft.

The above-mentioned fused yarn is preferably a core-sheath type composite filament yarn. As the above-mentioned core-sheath type composite filament yarn, those which are conventionally used as a core-sheath type fused yarn may be used without any particular limit and since being capable of firmly fixing the above-mentioned conductive fiber in the woven/knitted fabric and excellent in the size stability and morphology retention property at the time of forming a material, those which consist of a polyethylene terephthalate as a core component and a low melting point polyester as a sheath component are preferable.

It is preferable to use a copolymerized polyester obtained by copolymerizing a polyethylene terephthalate with isophthalic acid as the above-mentioned low melting point polyester. Additionally, as the low melting point polyester, those which have a melting point difference of 30° C. or higher from the melting point (generally 260° C.) of the polyethylene terephthalate are preferable to be used and for example, the melting point of a copolymerized polyester obtained by copolymerizing a polyethylene terephthalate with 15 to 35% by mole of isophthalic acid is in a range from 130 to 210° C.

Further, the bonding ratio of the core and sheath components of a core-sheath type composite filament yarn is preferably in a range from (6:4) to (2:8) and particularly preferably in a range from (5:5) to (3:7). If the sheath component is less than 40%, the adhesion property may be decreased in the case of formation and adhesion using this material and if it exceeds 80%, the core component is lessened, whereby the tensile strength of this material may possibly be decreased.

The single yarn fineness of the above-mentioned core-sheath type composite filament yarn is preferably in a range from 1 to 33 dtex and the number of filaments is preferably in a range from 10 to 30 in order to obtain proper strength and formability. Also, the above-mentioned core-sheath type composite filament yarn is preferable to be used in form of a filament yarn as it is in order to keep the strength and have dust-proofness.

The woven/knitted fabric of the invention using the above-mentioned core-sheath type composite filament yarn is obtained by fusion by melting the low meting point polyester according to the heating treatment for the woven/knitted fabric.

In the woven/knitted fabric of the invention, the ratio of the piling number of the above-mentioned core-sheath type composite filament yarn and the piling number of the non-conductive fiber other than the above-mentioned core-sheath type composite filament yarn (the number of core-sheath type composite filament yarn:the number of non-conductive fiber other than the core-sheath type composite filament yarn) is preferably in a range from (10:1) to (1:10).

The above-mentioned heating treatment maybe carried out at a temperature higher than the melting point of the low melting point component of the sheath of the composite filament yarn by at least 10° C., preferably by at least 15° C. and lower than the melting point of the polyethylene terephthalate.

As the non-conductive fiber, since the metal wire to be used as the conductive fiber has a dry thermal shrinkage ratio of approximately 0, those which have a low dry thermal shrinkage ratio are preferable to be used. Use of those having a low dry thermal shrinkage ratio as the non-conductive fiber doesn't cause extreme shrinkage during weaving and knitting or processing of dyeing etc. and thus suppresses occurrence of blister of the conductive fiber and increases the size stability of the woven/knitted fabric. Herein, the above-mentioned dry thermal shrinkage is measured according to filament shrinkage ratio (B method) defined in JIS L 1013 8.8.18.2. Practically, the dry thermal shrinkage ratio of the non-conductive fiber is preferable to be adjusted so as to keep the filament shrinkage ratio at 150° C. in 3% or lower.

As the non-conductive fiber showing low dry thermal shrinkage ratio as described, non-conductive fibers heat set by a heat roll or the like can be exemplified. A heat set method is not particularly limited and examples are a method of heating treatment at high temperature of 100 to 130° C. and high humidity under high pressure and a method of putting the fiber in a steam setter or in boiling water. Similarly, a method for improving the size stability, a method of using a temporarily twisted yarn can be exemplified.

The above-mentioned non-conductive fiber may be at least partially a high tensile strength yarn or a low tensile strength yarn. The high tensile strength yarn may practically be an aramide fiber. The low tensile strength yarn may practically be silk. In the case of using the high tensile strength yarn, a high pitch sound can be generated well and in the case of using the low tensile strength yarn, a low pitch sound can be generated well. Based on these findings, the capability of a speaker can be adjusted in accordance with the required functions for the speaker. Accordingly, these physical properties may properly be selected in accordance with the use purposes.

The above-mentioned conductive fiber may be metal wires of, such as copper, iron, gold, silver, and an alloy and among them, a copper wire is preferable since it has sufficient flexibility and conductivity and is economical. Especially, a copper wire coated with an alloy of copper and silver is preferable. If the fiber is the copper wire coated with an alloy of copper and silver, it is easy to have a desired strength by twisting a plurality of wires even in the case where the wire is relatively thin as 0.05 mm diameter. Further, as described above, twisting treatment is preferable since it prevents the metal wire from blister in a woven/knitted fabric. The above-mentioned conductive fiber may be a monofilament or a multifilament. Also, the fiber may be a coated conductive fiber coated by an organic material. In the case of a coated conductive fiber, it is preferable since electric leakage can be prevented. On the contrary to the coated conductive fiber, a fiber of an organic material such as a polyester coated by metal plating is also usable.

The above-mentioned coated conductive fiber is preferable to have a diameter in a range from a lower limit of 0.04 mm to an upper limit of 0.35 mm in terms of easiness of weaving. The diameter of the metal wire of the coated conductive fiber is preferably in a range from a lower limit of 0.025 mm to an upper limit of 0.30 mm.

Examples preferable to be used as the coated conductive fiber are Kuramo Magnet Wire, 1IMW-SN 0.1 mm, IPEW-N 0.1 mm manufactured by Kuramo Electric Co., Ltd. Further, the above-mentioned coated conductive fiber is preferable to be used while being paralleled in number of two or more. In the case where two or more of the coated conductive fiber are used while being paralleled, even if one is disconnected, other conductive fibers still remain and electric communication is maintained and accordingly it is preferable in terms of improvement of durability of a speaker. In the case of using the above-mentioned woven/knitted fabric as a diaphragm for a speaker, it is preferable to use the conductive fiber in number of two or more.

From a viewpoint of rust prevention, with respect to the above-mentioned coated conductive fiber, it is preferable to arrange two or more fibers coated with a resin such as a polyester, a polyamide, or a polyurethane in parallel and twist them. The number of the twisting is preferably 50 to 1000 T/M to keep the bundling property of the coated conductive fiber.

In the case where a plurality of coated conductive fibers are used, as shown in FIG. 1, those obtained by enclosing and bundling a coated conductive fiber in the center with a plurality of coated conductive fibers are preferable and if the fibers have a same diameter, for example, it is preferable that seven coated conductive fibers are bundled and twisted at 50 to 1000 T/M. As shown in FIG. 1, it is more preferable to use two units of the bundled seven coated conductive fibers while the two units are paralleled.

As described above, a yarn obtained by twisting a plurality of fibers with a thin diameter tends to be flexible and is preferable in terms of strength and weaving property. Also as described, even if one fiber is cut, electric communication is maintained and good flexibility is obtained in the case where the yarn is formed in a fabric and accordingly it is made easy to give excellent sound quality and volume and improved durability.

In the case where the above-mentioned woven/knitted fabric is used as a diaphragm for a speaker, it is preferable to use a material having a volume resistivity of 100 Ω·cm or lower at 20° C. as the above-mentioned conductive fiber. The volume resistivity is more preferably 10⁻² Ω·cm or lower. In this connection, the volume resistivity of copper is 10⁻⁸ Ω·cm.

The above-mentioned woven/knitted fabric has a woven structure or a knitted structure of the non-conductive fiber and a continuous wiring forming a coil of the conductive fiber. The coil shape formed using the above-mentioned conductive fiber is a continuous shape capable of functioning as the diaphragm for a speaker by sending electric signals and examples of the shape are illustrated in FIG. 2 to FIG. 8.

Hereinafter, referring to FIG. 2, the woven/knitted fabric of the invention consisting of the above-mentioned conductive fiber and the above-mentioned non-conductive fiber will be described.

One example of the woven/knitted fabric of the invention is shown in FIG. 2. The example shown in FIG. 2 is a woven fabric 11 using the above-mentioned non-conductive fiber 12 as a warp and the above-mentioned conductive fiber 13 as a weft. The continuous wiring forming the coil of the above-mentioned conductive fiber has a coil-like shape in which the conductive fiber is continued and same patterns are repeated. The above-mentioned coil-like shape is, for example, the shape illustrated in FIG. 2. That is, in the example shown in FIG. 2, the coil-like shape is formed by repeating patterns of orienting the conductive fiber 13 from the periphery of the left rim to the periphery of the right rim while forming a portion of the woven structure substantially in parallel to weft and composing a portion of the inter-warp width with a constant gap and successively orienting the conductive fiber 13 from the periphery of the right rim to the periphery of the left rim while forming another portion of the woven structure substantially in parallel to the weft. Other examples of the coil-like shape may be a polygonal spiral shape as shown in FIG. 4, a circular spiral shape as shown in FIG. 5, and a continuously combined shape consisting of a plurality of spiral forms as shown in FIG. 8.

In the case where the woven/knitted fabric of the invention is a woven fabric obtained by using the above-mentioned non-conductive fiber and the above-mentioned conductive fiber as a warp and the non-conductive fiber as a weft, the conductive fiber woven as a portion of the warp has similarly the coil-like shape described above.

The above-mentioned coil-like shape may be formed by weaving the conductive fiber so as to form a portion of the woven structure or by knitting the conductive fiber so as to form a portion of the knitted structure with the above-mentioned coil-like shape respectively, or by other methods.

In the case where the above-mentioned coil-like shape is formed by weaving the conductive fiber as to form a portion of the woven structure with the above-mentioned coil-like shape, a weaving machine for weaving the continuous coil may be machines such as a ribbon weaving machine and a fly shuttle which can take in and weave the conductive fiber of copper or the like along a bobbin so as not to twist the conductive fiber of copper or the like.

In the case where the above-mentioned coil-like shape is formed by weaving the conductive fiber as to form a portion of the woven structure with the above-mentioned coil-like shape, since the conductive fiber is firmly fixed in the woven fabric, in the case where the woven fabric is used as a diaphragm for a speaker, a problem that the coil is shifted due to the vibration can be prevented and therefore, it is more preferable.

In the case where the above-mentioned coil-like shape is formed by weaving the conductive fiber so as to form a portion of the woven structure with the above-mentioned coil-like shape, the structure is preferable to be satin or twill fabric structure with the above-described coil-like shape. In this case, the conductive fiber of copper or the like exists only in one face side of the woven fabric and the conductive fiber is kept more straight and tense in the woven fabric. Therefore, in the case where the woven fabric described above is used as a diaphragm for a speaker, the conductive fiber in the coil-like shape is not so soft and sufficiently exhibits the function of generating vibrations and consequently, generates large sound and widens the range of the sound pitch. Further, to keep the tension of the woven fabric, it is preferable to use a fused yarn and/or a high tensile strength yarn.

As a production method of the woven/knitted fabric of the invention, the woven/knitted fabric can be produced using a commonly used weaving machine or knitting machine by weaving the conductive fiber so as to form a portion of the woven structure with the above described coil-like shape or knitting the conductive fiber so as to form a portion of the woven structure with the above described coil-like shape.

Also as another production method of the woven/knitted fabric of the invention, there are, for example, a method of bonding a coil with an adhesive after the woven fabric is produced or the knitted fabric is produced and a method of sticking a film and further bonding a coil after the woven fabric is produced or the knitted fabric is produced.

That is, the woven/knitted fabric of the invention includes those obtained by bonding a coil produced by using a conductive fiber to a woven/knitted fabric produced by using a non-conductive fiber.

The woven/knitted fabric of the invention may be coated with a resin. In the case where the woven/knitted fabric of the invention is coated with a resin, it can be produced by resin coating the woven/knitted fabric produced by the above-mentioned method. A coating composition to be used for the above-mentioned coating with a resin is not particularly limited and for example, a urethane resin can be exemplified.

In the case where the above-mentioned woven/knitted fabric is used as a diaphragm for a speaker, the continuous wiring (the coil-like shape) forming a coil of the above-mentioned conductive fiber in the woven/knitted fabric is enabled to advantageously function as a coil in the diaphragm for a speaker. Accordingly, the woven/knitted fabric of the invention obtained by forming the coil-like shape as described above using the conductive fiber can be a diaphragm having the same function as that of a diaphragm for a panel speaker in which a coil is formed by a conventional printing method.

In the case where the above-mentioned woven/knitted fabric is used as a diaphragm for a speaker, the cross-sectional shape of the above-mentioned conductive fiber is not particularly limited, however in order to give good vibration as a coil of a speaker, the fiber diameter is preferably in a range from a lower limit of 0.03 mm to an upper limit of 0.3 mm. If it is thinner than 0.03 mm, the sound volume of a speaker may possibly be lowered. If it is thicker than 0.3 mm, in the case where the woven/knitted fabric is obtained by weaving the conductive fiber, it sometime becomes difficult to weave the fiber. Further, if the fabric is folded, the folding line may be left in some cases. The lower limit is more preferably 0.05 mm and even more preferably 0.07 mm. The upper limit is more preferably 0.2 mm and even more preferably 0.15 mm.

In the case where the woven/knitted fabric of the invention is used as a diaphragm for a speaker, the continuous wiring forming a coil of the above-mentioned conductive fiber is not particularly limited if it has a shape suitable for functioning as a coil of a speaker and may properly be determined.

In the case where the woven/knitted fabric of the invention is used as a diaphragm for a speaker and the fabric is obtained by weaving using the conductive fiber and the non-conductive fiber as the weft and the non-conductive fiber as the warp, the ratio of the piling number of the above-mentioned conductive fiber in the row direction and the piling number of the above-mentioned non-conductive fiber in the row direction (the number of the conductive fiber/the number of the non-conductive fiber) is preferably ½ or lower and more preferably ⅕ or lower and even more preferably 1/20 or lower. If it exceeds ½, the neighboring conductive fibers may be brought into contact with each other at the time of disconnection. It is also same in the case of a woven fabric obtained by weaving using the conductive fiber and the non-conductive fiber as the warp and the non-conductive fiber as the weft.

Weight of the woven/knitted fabric of the invention is preferably in a range from 50 to 800 g/m², more preferably in a range from 100 to 500 g/m², and even more preferably in a range from 150 to 400 g/m². If it is too large, in the case of using it for a diaphragm for a speaker, the sound volume and sound quality may possibly be decreased. In the case where the woven/knitted fabric of the invention is coated with a resin, weight is the value after the coating with a resin.

As described above, the above-mentioned woven/knitted fabric is preferably usable for a diaphragm for a speaker. A diaphragm for a speaker made of the above-mentioned woven/knitted fabric is also included in the invention. The above-mentioned woven/knitted fabric is also expected to be usable as a circuit pattern.

The above-mentioned diaphragm for a speaker can be used preferably as a speaker by using, for example, a rod-type magnet in combination. A speaker comprising the above-mentioned diaphragm for a speaker is also included in the invention.

The speaker of the invention may have the same structure as that of a conventionally known speaker, except that the above-mentioned woven/knitted fabric is used as the diaphragm for a speaker and the arrangement of the magnet and the size may be same as those of a conventional one.

Examples of the speaker of the invention are shown in FIG. 3 to FIG. 8. The speaker 21 shown in FIG. 3 is produced by arranging a plurality of rod-type magnets 23 in parallel on a yoke 22 and successively laminating a cloth 25 as a buffer material and a diaphragm 24 (the above-mentioned woven/knitted fabric), in which the coil is formed in parallel to the magnetic pole face of the rod-type magnets 23, in this order. The rod-type magnets 23 are arranged in a manner of arranging S pole, N-pole, and S-pole in this order on the yoke 22. The starting end and the terminal end of the conductive fiber are used as electrodes and when electric current is applied to the coil, the diaphragm 24 in which the coil is formed is vibrated in the direction at right angles to the plane of the diaphragm and accordingly the electric signals can be converted into the acoustic signals. A unit comprising the above-mentioned speaker 21, an amplifier, and a sound source such as a headphone can work as a speaker.

A method of fixing the respective layers of the speaker 21 produced by laminating the above-mentioned yoke 22, the rod-type magnets 23, the cloth 25, and the diaphragm 24 in which the coil is formed in this order is not particularly limited if the method is proper to fix the respective layers and for example, a method of fixing them with screws, an adhesive or the like can be exemplified. Particularly, in terms of stable fixation, fixation with screws is preferable.

The above-mentioned yoke 22 to be used may be those which have the same form as that of the speaker, however as the speaker 21 shown in FIG. 3, those having a smaller size than that of the speaker may be arranged at prescribed intervals from each other. Accordingly, the speaker 21 is made lightweight and in the case where the speaker is used as a screen, it can be easily rolled and therefore, it is preferable.

In the case where yokes 22 having a smaller size than that of the speaker are arranged at prescribed intervals from each other, the interval of the respective yokes 22 is preferably in a range from 0.5 to 10 mm and more preferably in a range from 2 to 4 mm. As described, separation of the yokes is suitable for rolling the speaker like a roll. Also, in the case of using the speaker in such a manner, it is preferable for the yokes 22 in the speaker 21 as shown in FIG. 3 that each yoke 22 has a size corresponding to the one cycle unit of the coil-like shape in order to cause the effect most efficiently.

As a substrate to be used for the yokes 22, for example, a iron plate, a plastic, or Duralumin can be used. Among them, in the case where high sound volume is to be generated, an iron plate is preferable since it does not cause leakage of magnetism downward. Further, the yoke is generally used for preventing loss of the magnetism, and in the case where it is no need to generate high sound volume, a material which releases magnetism may be used as a protection material (yoke). In the case where the material which releases magnetism is used, in order to make the speaker lightweight, a plastic or Duralumin is preferable to be used. In the case of the material which releases magnetism, since it can be a magnet, it can be attracted to a material having magnetism and the resulting speaker becomes easy to be used widely.

In the above-mentioned speaker 21, the above-mentioned rod-type magnets 23 are used, however smaller magnets may be used in stead, while being arranged. In the case of using small magnets, the speaker can be made lightweight. A material to be used as the magnets is not particularly limited and those which have conventionally been known may be used and examples are Alnico, ferrite, rare earth metals, rare earth metal-iron, and the like. Among them, rubber molded rare earth metal-iron powders are preferable since they are light and thin and have strong magnetism. With respect to the above-mentioned rod-type magnets 23, rod-type magnets 23 are arranged in a manner of arranging the S pole, N pole, and S pole in this order on each of four yokes 22 in FIG. 3, however they may be arranged in the order of the N pole, S pole, and N pole.

In the above-mentioned speaker 21, the portion of the conductive fiber forming the coil-like shape parallel to the rod-type magnets 23 is theoretically most preferable to be arranged in the boundary of the S pole and the N pole to evenly generate vibration. However, if the portion is positioned in the above-mentioned boundary, the coil is shifted by the vibration of the speaker and unevenly vibrated to result in fragmentation of the sound. Therefore, the portion of the coil-like shape parallel to the rod-type magnets 23 is preferable to be shifted slightly from the boundary. Further, since the magnetism flows from the N pole to the S pole, as shown in FIG. 3, it is preferable to shift the portion to the S pole side but not to the N pole side. Accordingly, even if shifting occurs, the coil-like shape can function as an evenly vibrating diaphragm.

The shifting width of the portion of the coil-like shape parallel to the rod-type magnets 23 to the S pole side is preferably in a range from 0.1 to 1.0 mm and particularly preferably in a range from 0.4 to 0.6 mm. If it is narrower than 0.1 mm, the coil may possibly be shifted. If it exceeds 1.0 mm, vibration cannot be generated evenly, resulting fragmentation of sound.

In the above-mentioned speaker 21, the cloth 25 installed between the rod-type magnets 23 and the diaphragm 24 in which the coil is formed may be, for example, a woven cloth, a nonwoven cloth, and a knitted cloth. The cloth is better as it is soft and a nonwoven cloth is desirable. Also, in order to absorb the vibration, it is more desirable to have a thicker thickness. The above-mentioned nonwoven cloth is not particularly limited, however it is preferable to have weight in a range from 10 to 100 g/m². In place of the cloth 25, paper may be installed. Installation of the cloth, paper or the like generates a slight space between the rod-type magnets 23 and the diaphragm 24 in which the coil is formed and therefore, the vibration is easy to be transmitted to generate high sound volume and further noise generation can be prevented.

A speaker 21 shown in FIG. 4 comprises a magnet 23, a cloth 25 as a buffer material, and a diaphragm 24 in which the coil is formed in the spiral shape layered in this order on a yoke 22. The magnet 23 is preferable to have an enough size to cover the outer circumference of the coil. The orientation of the N pole and the S pole of the magnet 23 is not particularly limited, however it is preferable to be arranged so as to make electric power flows.

A speaker 21 shown in FIG. 5 comprises a cylindrical magnet 23, a cloth 25 as a buffer material, and a diaphragm 24 in which the coil is formed in the circular shape layered in this order on a yoke 22. The magnet 23 to be used may be those having a doughnut-like shape as shown in FIG. 6 and FIG. 7.

A speaker 21 shown in FIG. 8 comprises a magnet 23 having a shape corresponding to the coil, a cloth 25 as a buffer material, and a diaphragm 24 in which the coil is formed in a triangular or rectangular shape layered in this order on a yoke 22. The magnet 23 has the shape corresponding to the coil or a magnet having an enough size to entirely cover the coil may be installed.

Since the speaker of the invention comprises the above-mentioned woven/knitted fabric, the number and the density of the copper wire can easily be designed without restrain and set as compared in the case of using a film or the like and also, the sound volume or the like can be set easily.

### EFFECT OF THE INVENTION

With respect to the woven/knitted fabric of the invention, having the above-mentioned constitution, the conductive fiber in the woven/knitted fabric forms the coil and therefore, the woven/knitted fabric can be used preferably for a diaphragm for a speaker. Also, as compared with a conventional diaphragm for a speaker, since it can be produced by a simple production method, it can be produced at a low production cost. Further, the woven/knitted fabric is excellent in the flexibility and bending property.

### BRIEF DESCRIPTION OF THE DRAWINGS

FIG. 1 is a schematic drawing of one example of a bundle of a plurality of coated conductive fibers of the invention.

FIG. 2 is a schematic drawing of one example of the woven/knitted fabric of the invention.

FIG. 3 is a schematic drawing of one example of the speaker of the invention.

FIG. 4 is a schematic drawing of another example of the speaker of the invention.

FIG. 5 is a schematic drawing of another example of the speaker of the invention.

FIG. 6 is a schematic drawing of another example of the speaker of the invention.

FIG. 7 is a schematic drawing of another example of the speaker of the invention.

FIG. 8 is a schematic drawing of another example of the speaker of the invention.

FIG. 9 is a schematic drawing of a coil-like shape of a woven fabric of Example.

FIG. 10 is a schematic drawing of the positioning of the yoke, the rod-type magnets, and the coil in the speaker obtained in Example 4.

FIG. 11 is a cross-sectional view along the line A-A of FIG. 10.

FIG. 12 is a schematic drawing of the positioning of the yoke, the rod-type magnets, and the coil in the speaker obtained in Example 5.

FIG. 13 is a schematic drawing of the base structure of the woven fabric of Example 8.

FIG. 14 is a schematic drawing of the bag structure of the woven fabric of Example 8.

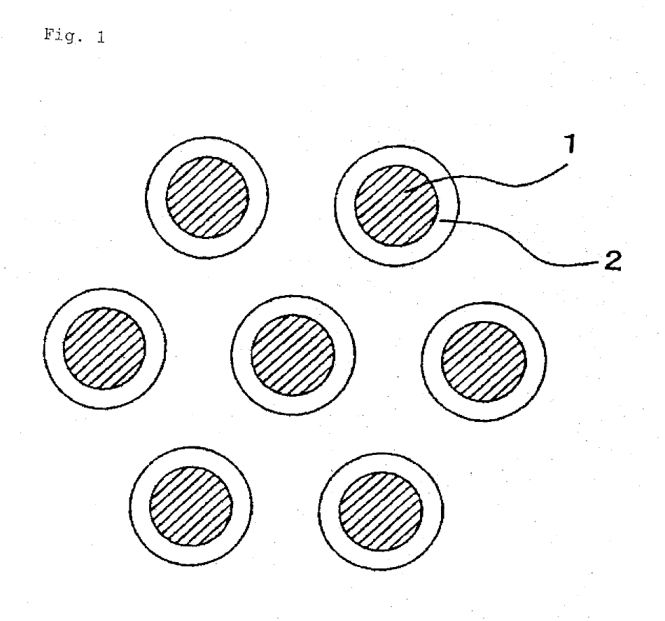

### EXPLANATION OF SYMBOLS

1 conductive fiber
2 coating layer
11 woven fabric
12 non-conductive fiber
13 conductive fiber
21 speaker
22 yoke
23 magnet
24 diaphragm having coil formed thereon
25 cloth
26 coil

### BEST MODES FOR CARRYING OUT THE INVENTION

Hereinafter, the invention will be described more particularly with reference to examples, however it is not intended that the invention be limited to only the described examples. In the examples, “part” and “%” mean “part by mass” and “% by mass”, respectively, unless otherwise specified.

### Example 1

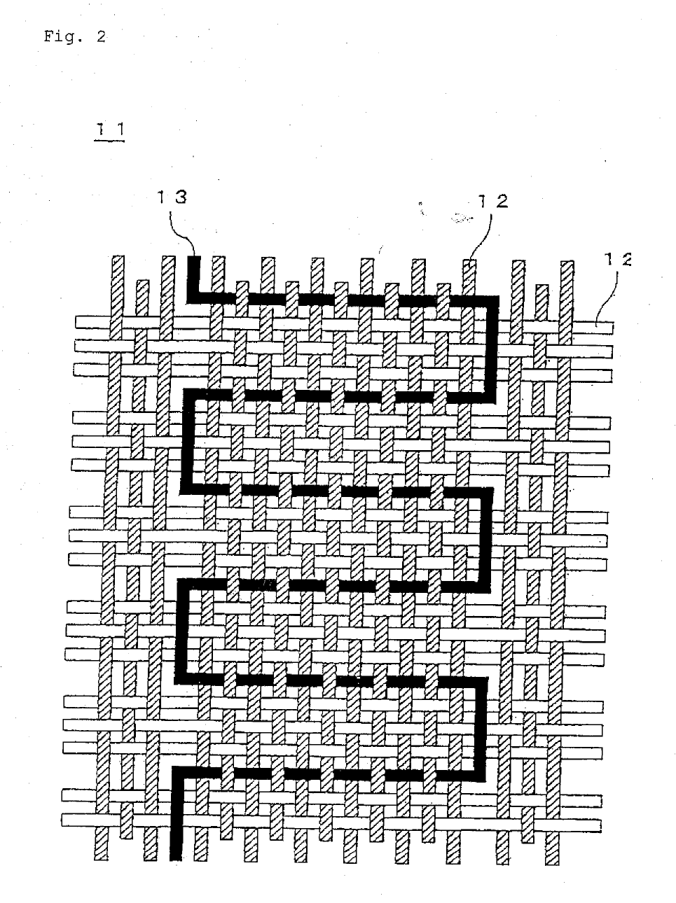

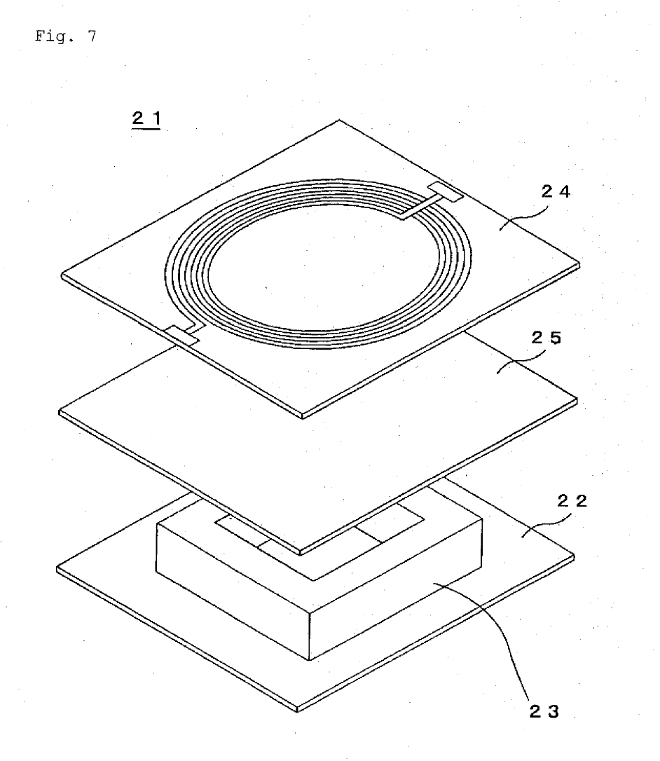

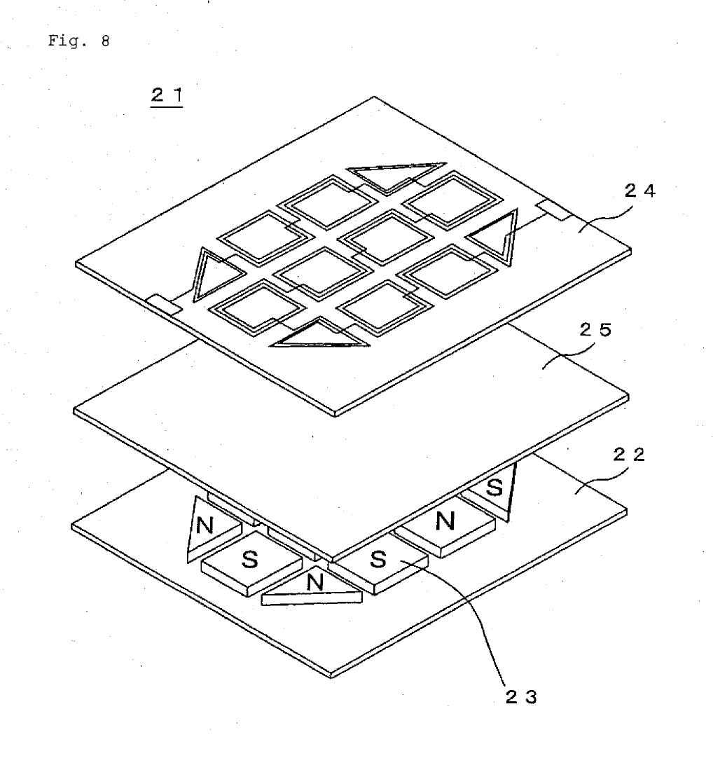

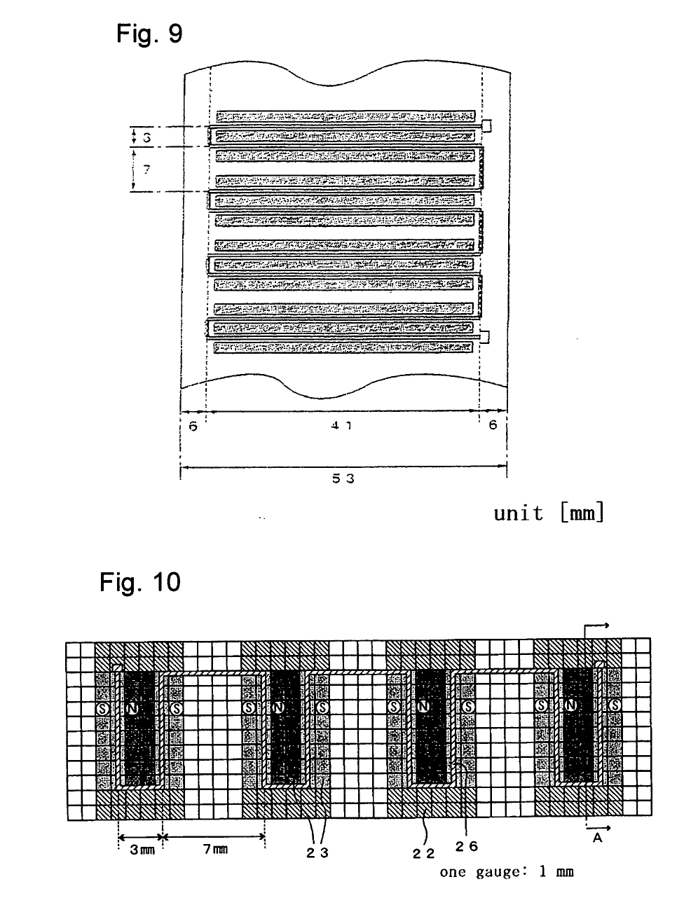

Parallel yarns each made of two polyester multifilaments with 33.3 dtex/36 f (s900 (downward twisting)/z 600 (upward twisting)) were used as a warp and on the other hand, polyester multifilaments with 83.3 dtex/72 f and a core-sheath structure fused yarn (83.3 dtex/24 f) obtained by conjugating a polyester fiber having a melting point of 230° C. as a core material with a modified polyester having a melting point of 180° C. as a sheath material to form a thermally fusible layer on the surface of the core material were used as the weft at 1:1 and further as a portion of the weft, two parallel copper wires coated with a polyester and having a diameter of 0.1 mmφ were used and accordingly, a twill fabric in which a coil-like shape shown in FIG. 2 and FIG. 9 was formed was woven as a substrate. The piling number was 130/2.54 cm for the warp and 90/2.54 cm for the weft.

While being pinched from the upper side and the lower side by a clump with a disk shape having a hole with an inner diameter in the center which was sufficiently larger than the outer diameter of a formed product, the substrate was fixed in tense state and set at 200° C. for 20 seconds to melt the thermally fusible layer on the substrate to complete the twill fabric. Weight of the twill fabric was 90 g/m².

### Example 2

A woven fabric was produced in the same manner as Example 1, except that parallel yarns each made of two polyester multifilaments with 83.3 dtex/72 f (s900 (downward twisting)/z 600 (upward twisting)) were used as a warp and polyester multifilaments with 83.3 dtex/72 f (s300) and a core-sheath structure fused yarn (83.3 dtex/24 f) obtained by conjugating a polyester fiber having a melting point of 230° C. as a core material with a modified polyester having a melting point of 180° C. as a sheath material to form a thermally fusible layer on the surface of the core material were used as the weft at 1:1 and further as a portion of the weft, two parallel copper wires coated with a polyester and having a diameter of 0.1 mmφ were used. The piling number was 166/2.54 cm for the warp and 90/2.54 cm for the weft. Weight of the twill fabric was 175 g/m².

### Example 3

A woven fabric was produced in the same manner as Example 1, except that parallel yarns each made of two polyester multifilaments with 83.3 dtex/72 f (s 900 (downward twisting)/z 600 (upward twisting)) were used as a warp and polyester multifilaments with 83.3 dtex/72 f (s300) were used as the weft and further as a portion of the weft, two parallel copper wires coated with a polyester and having a diameter of 0.1 mmφ were used. The piling number was 166/2.54 cm for the warp and 90/2.54 cm for the weft. Weight of the twill fabric was 175 g/m².

### Example 4

### Production of Speaker

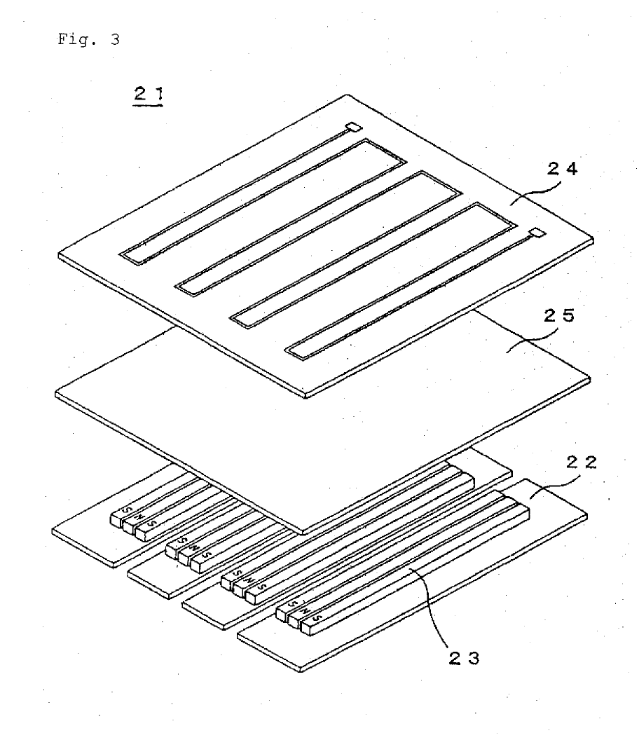

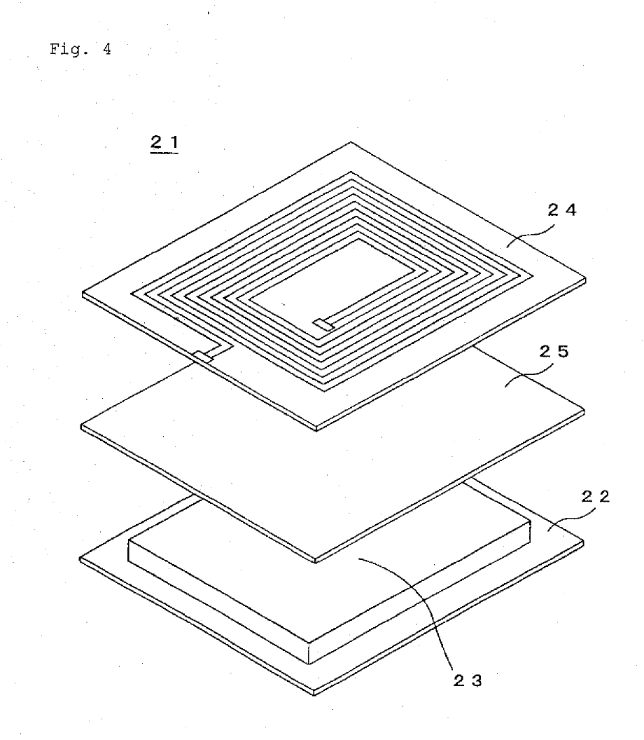

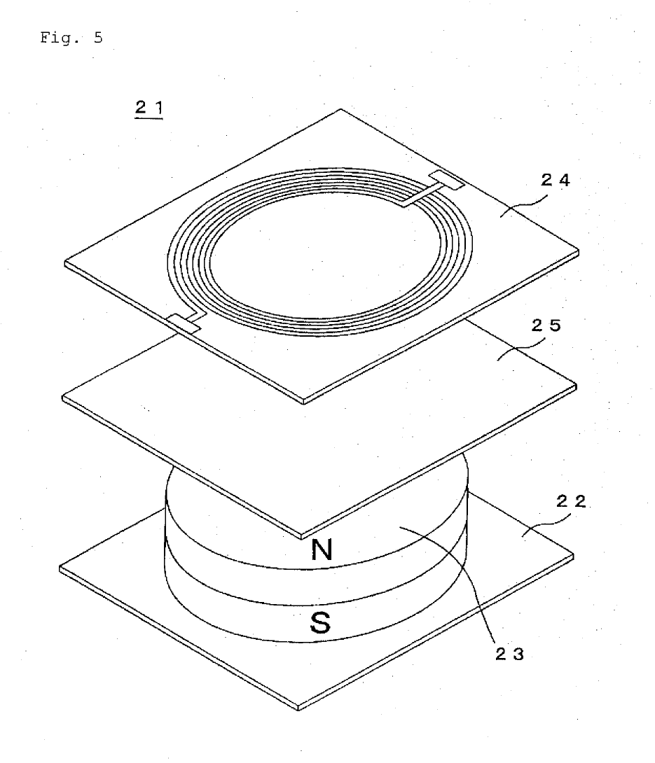

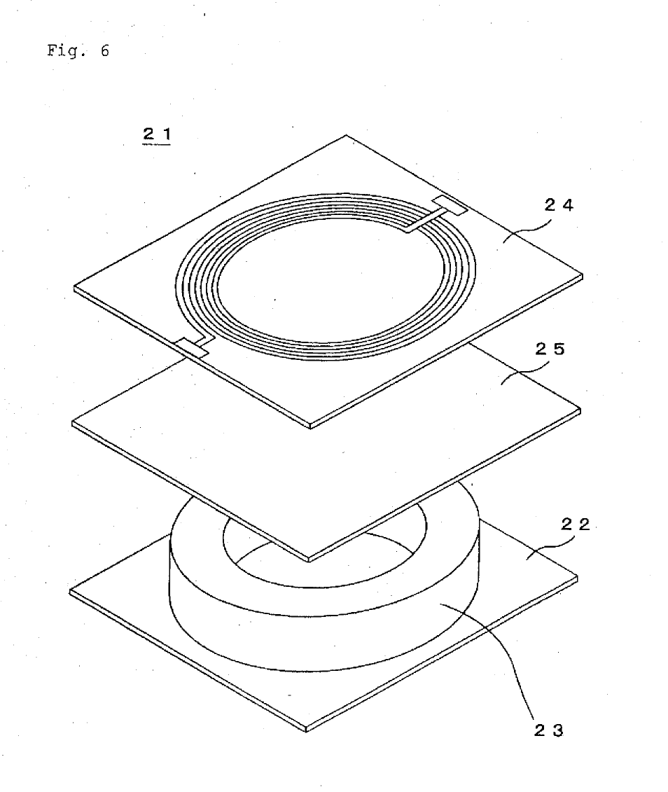

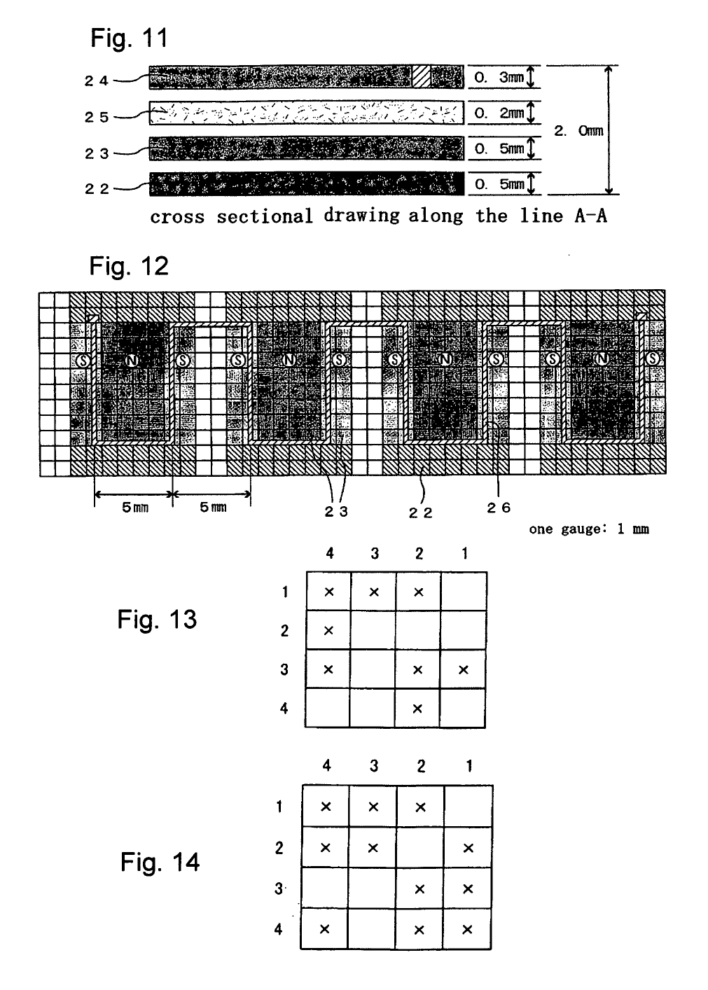

A speaker shown as the schematic drawing of FIG. 3 was produced in the same method. FIG. 10 shows the positions of the yoke, the rod-type magnets, and the coil and FIG. 11 is a cross-sectional drawing along the line A-A in FIG. 10.

At first, rod-type magnets 23 were put on a yoke 22 (0.5 mm-thick iron plate). Herein, the rod-type magnets 23 were arranged alternating the N pole and the S pole. Next, a cloth (nonwoven cloth) 25 was put on the yoke 22 on which the rod-type magnets 23 were put and further a diaphragm 24 on which a coil was formed was put on the yoke while sandwiching the cloth (nonwoven cloth) 25 and the yoke 22 and the diaphragm 24 on which the coil was formed in both sides were fixed with screws while sandwiching the cloth (nonwoven cloth) 25 between them. The thickness of the produced speaker was 2.0 mm.

Next, the starting end and the terminal end of the conductive fibers were soldered to form electrodes and the respective electrodes were connected an amplifier and further the amplifier and a sound source were connected. The diaphragm could function well in the speaker 21 by inputting sound from the sound source. The diaphragm 24 was obtained using the twill fabric of Examples 1 to 3.

### Example 5

### Production of Speaker

A speaker was produced in the same manner as Example 4, except that the yoke, the rod-type magnet, and the coil were arranged in the positioning relation shown in FIG. 12. The thickness of the produced speaker was 2.0 mm. The diaphragm could function well in the speaker same as Example 4. The diaphragm 24 used here was a 5 mm-5 mm type diaphragm in place of the 7 mm-3 mm type used in Example 4.

The speaker which is the best in sound volume to be generated among the speakers produced in Example 4 and Example 5 was a speaker produced using the twill fabric of Example 2 and the speaker which is the second in sound volume to be generated was a speaker produced using the twill fabric of Example 1 and the speaker which is the third in sound volume to be generated was a speaker produced using the twill fabric of Example 3.

With respect to the speakers produced in Example 4 (7 mm-3 mm type) and Example 5 (5 mm-5 mm type), the one produced in Example 4 was easy to rolling and the one produced in Example 5 was excellent in mass productivity.

### Example 6

A woven fabric was produced in the same manner as Example 1, except that parallel yarns each made of two polyester multifilaments/with 150 dtex 96 f (s 700 (downward twisting)/z 400 (upward twisting)) were used as a warp and polyester multifilaments with 167 dtex/96 f (s300) and a core-sheath structure fused yarn (167 dtex/16 f) obtained by conjugating a polyester fiber having a melting point of 230° C. as a core material with a modified polyester having a melting point of 180° C. as a sheath material to form a thermally fusible layer on the surface of the core material were used as the weft at 1:1 and further as a portion of the weft, a double folded yarn obtained by arranging seven parallel coated copper wires, each of which was obtained by coating a copper wire with a copper-silver alloy and further with a polyester and having a diameter of 0.06 mmφ in form of a coated wire, and twisting the coated copper wires at 400 T/M in S-direction were used. The piling number was 60/2.54 cm for the warp and 70/2.54 cm for the weft.

### Example 7

### Production of Speaker

A speaker was produced in the same manner as Example 5, except that the woven fabric obtained in Example 6 was used (5 mm-5 mm type).

The speaker produced in Example 7 could function as a speaker same as those of Example 4 and Example 5. As compared with those produced in Example 4 and Example 5, the speaker produced in Example 7 was excellent for generating sound with more excellent sound quality and higher sound volume with scarce noise. Further, the sound quality and sound volume were good even if the speaker was used for a long duration.

### Example 8

A woven fabric was produced in the same manner as Example 1, except that parallel yarns each made of two polyester multifilaments with 167 dtex/96 f (s 700 (downward twisting)/z 400 (upward twisting)) were used as a warp and polyester multifilaments with 167 dtex/96 f (s300) and a core-sheath structure fused yarn (167 dtex/16 f) obtained by conjugating a polyester fiber having a melting point of 255° C. as a core material with a modified polyester having a melting point of 180° C. as a sheath material to form a thermally fusible layer on the surface of the core material were used as the weft at 1:1 and further as a portion of the weft were used two parallel double-folded-yarns each obtained by arranging seven parallel coated copper wires, each of which was obtained by coating a copper wire with a copper-silver alloy and further with a polyester and having a diameter of 0.06 mmφ in form of a coated wire, and twisting the coated copper wires at 400 T/M in S-direction and the base was made to have the 3/1 structure as shown in FIG. 13 and the ear was made to be bag structure as shown in FIG. 14 and the yoke, the rod-type magnets, and the coil were arranged in the positioning as shown in FIG. 12 and the distance between neighboring copper wires was adjusted to 5 mm-5 mm. The piling number was 166/2.54 cm for the warp and 70/2.54 cm for the weft. Weight of the twill fabric was 378 g/m².

### Example 9

### Production of Speaker

A speaker was produced in the same manner as Example 5, except that the twill fabric obtained in Example 8 was used (5 mm-5 mm type).

As compared with the speaker produced in Example 7, the speaker produced in Example 9 was capable of generating sound with further higher sound volume and wider pitch.

### INDUSTRIAL APPLICABILITY OF THE INVENTION

A woven/knitted fabric of the invention is preferably usable for a diaphragm for a speaker and owing to the form, it is particularly preferably usable for a diaphragm for a panel speaker. Further, the woven/knitted fabric is produced using a conductive fiber, it is expected to be used as a circuit pattern.

1. A speaker comprising a diaphragm, wherein the diaphragm comprises a woven/knitted fabric comprising a conductive fiber and a non-conductive fiber, the woven/knitted fabric having a woven structure or a knitted structure of said non-conductive fiber and a continuous wiring forming a coil of the conductive fiber.

2. The speaker according to claim 1, wherein the coil is formed in the woven structure or the knitted structure by weaving or knitting the conductive fiber by a weaving machine or a knitting machine.

3. The speaker according to claim 1, wherein at least a portion of the non-conductive fiber is a fusible yarn.

4. The speaker according to claim 1, wherein the conductive fiber is a copper wire.

5-6. (canceled)

7. The speaker according to claim 1, comprising a buffer material between the diaphragm for a speaker and a magnet.

8. The speaker according to claim 1, as an interior material for a room or an automobile.

9. A noise control system comprising the speaker according to claim 1.

10. A sound navigation system comprising the speaker according to claim 1.

11. A display equipped with sound guidance comprising the speaker according to claim 1.

12. The speaker according to claim 2, wherein at least a portion of the non-conductive fiber is a fusible yarn.

13. The speaker according to claim 2, wherein the conductive fiber is a copper wire.

14. The speaker according to claim 3, wherein the conductive fiber is a copper wire.

15. The speaker according to claim 7 as an interior material for a room or an automobile.

16. A noise control system comprising the speaker according to claim 7.

17. A sound navigation system comprising the speaker according to claim 7.
